(19) United States
(12) Patent Application Publication
(10) Pub. No.: US 2024/0367644 A1
(43) Pub. Date: Nov. 7, 2024

(54) PARKING ASSIST SYSTEM AND PARKING ASSIST METHOD

(71) Applicant: Panasonic Automotive Systems Co., Ltd., Kanagawa (JP)

(72) Inventors: Ryo OTSUKI, Nara Ken (JP); Masayuki FUKUYAMA, Osaka Fu (JP); Yudai ISHIBASHI, Kanagawa Ken (JP)

(73) Assignee: Panasonic Automotive Systems Co., Ltd., Kanagawa (JP)

(21) Appl. No.: 18/776,936

(22) Filed: Jul. 18, 2024

Related U.S. Application Data
(63) Continuation of application No. PCT/JP2023/000319, filed on Jan. 10, 2023.

(30) Foreign Application Priority Data
Mar. 30, 2022 (JP) 2022-057058

(51) Int. Cl. B60W 30/06; B62D 15/02; G06V 20/58

(52) U.S. Cl. CPC B60W 30/06; B62D 15/0285; G06V 20/586; B60W 2420/403; B60W 2420/408; B60W 2552/53; B60W 2554/20; B60W 2554/80; B60W 2754/10

(57) ABSTRACT

A parking assist system according to an embodiment includes a processor connected to a memory. The processor detects a parking frame around a vehicle based on a photographed image obtained by photographing surroundings of the vehicle. The processor detects a parking space based on ultrasonic transmitted waves and reflected waves of the ultrasonic transmitted waves. The processor determines accuracy of the parking frame. The processor determines, based on the accuracy of the parking frame, a method of calculating a target parking position using the parking frame and the parking space. The processor calculates the target parking position based on the determination on the method of calculating the target parking position. The processor generates a route based on the target parking position.

### CROSS-REFERENCE TO RELATED APPLICATIONS

This application is a continuation of International Application No. PCT/JP2023/000319, filed on Jan. 10, 2023, which claims the benefit of priority of the prior Japanese Patent Application No. 2022-057058, filed on Mar. 30, 2022, the entire contents of which are incorporated herein by reference.

### FIELD

Embodiments described herein relate generally to a parking assist system and a parking assist method.

### BACKGROUND

In recent years, regarding a parking assist device, there is known a technique of converting a camera image into an overhead image, and extracting a straight line to detect a parking frame line (for example, Japanese Patent Application Laid-open No. 2013-001366).

However, there is a case where a vehicle currently driving and a parking frame are not present on the same plane, such as that the parking frame is located on a place higher or lower than of a place where the vehicle is present. In such a case, there is a possibility that a shape of the parking frame extracted from the image is deformed and thereby a target position of parking cannot be appropriately calculated based on the parking frame extracted from the image.

### SUMMARY

A parking assist system according to an embodiment includes a hardware processor connected to a memory. The hardware processor is configured to detect a parking frame around a vehicle based on a photographed image obtained by photographing surroundings of the vehicle. The hardware processor is configured to detect a parking space based on ultrasonic transmitted waves and reflected waves of the ultrasonic transmitted waves. The hardware processor is configured to determine accuracy of the parking frame, and determine, based on the accuracy of the parking frame, a method of calculating a target parking position using the parking frame and the parking space. The hardware processor is configured to calculate the target parking position based on the determination on the method of calculating the target parking position. The hardware processor is configured to generate a route based on the target parking position.

### BRIEF DESCRIPTION OF THE DRAWINGS

FIG. 1 is a schematic diagram illustrating an example of a vehicle including a parking assist system according to a first embodiment;

FIG. 2A is a diagram for explaining a parking situation according to the first embodiment;

FIG. 2B is a diagram for explaining an overhead image according to the first embodiment;

FIG. 2C is a diagram for explaining a parking situation according to the first embodiment;

FIG. 2D is a diagram for explaining an overhead image according to the first embodiment;

FIG. 3 is a flowchart illustrating a processing procedure according to the first embodiment;

FIG. 4A is a diagram for explaining a parking situation according to a second embodiment;

FIG. 4B is a diagram for explaining a parking situation according to the second embodiment;

FIG. 4C is a diagram for explaining an overhead image according to the second embodiment;

FIG. 4D is a diagram for explaining a parking situation according to the second embodiment; and

FIG. 5 is a flowchart illustrating a processing procedure according to the second embodiment.

### DETAILED DESCRIPTION

### First Embodiment

The following describes a first embodiment with reference to the drawings.

### Configuration Example of System

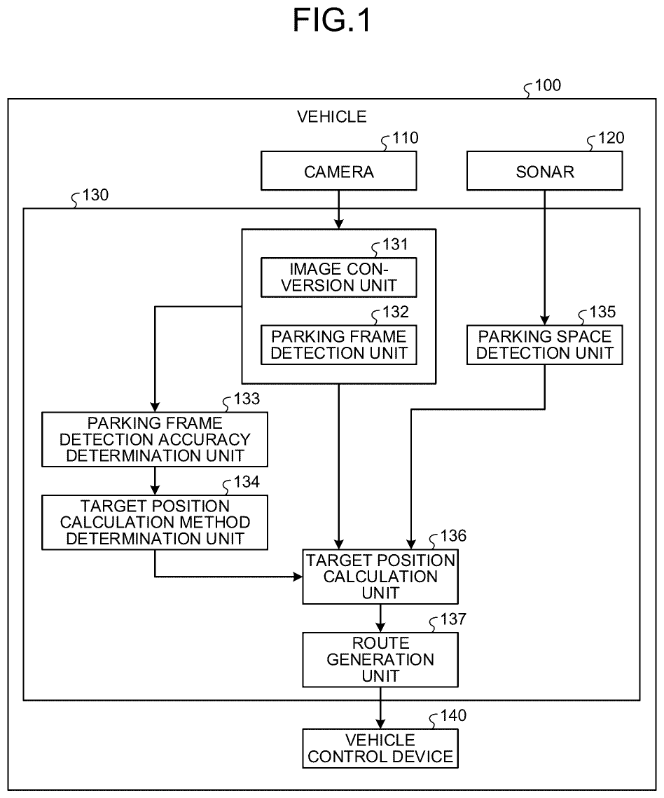

FIG. 1 is a schematic configuration diagram illustrating an example of a vehicle according to the first embodiment. A vehicle 100 includes a camera 110, sonar 120, a parking assist device 130, and a vehicle control device 140.

In one example, the camera 110 is a visible light camera.

The vehicle 100 includes a first imaging device that images a front side of the vehicle, a second imaging device that images a rear side of the vehicle, a third imaging device that images a left side of the vehicle, and a fourth imaging device that images a right side of the vehicle.

The camera 110 is used for, for example, detecting feature points of an object present around the vehicle 100 and estimating a current position of the vehicle 100 based on a positional relation between the vehicle 100 and the feature points. The camera 110 outputs taken image signals to the parking assist device 130. The camera 110 is not limited to the visible light camera, but may be a CCD camera, a CMOS camera, etc. The image to be taken may be a static image or a moving image.

In one example, the sonar 120 is ultrasonic sonar. When the vehicle 100 is moving in a parking lot, the sonar 120 emits ultrasonic waves and detects a distance to an obstacle present around the vehicle 100 on the basis of reflected waves that are reflected and detected. Then, the sonar 120 calculates contour points of the obstacle based on the distance to the obstacle, and detects feature points of the obstacle based on the contour points. Two or more pieces of the sonar 120 are provided at least on a front face of the vehicle 100.

The parking assist device 130 is a device that outputs a route from a position of the vehicle 100 to a parking target position. Details about the parking assist device 130 will be described later.

The vehicle control device 140 is a device that controls the vehicle 100. The vehicle control device 140 is an engine actuator, a brake actuator, an actuator, and so forth. The vehicle control device 140 performs driving control for the vehicle 100 based on the route acquired from the parking assist device 130.

The parking assist device 130 includes an image conversion unit 131, a parking frame detection unit 132, a parking frame detection accuracy determination unit 133, a target position calculation method determination unit 134, a parking space detection unit 135, a target position calculation unit 136, and a route generation unit 137.

The image conversion unit 131 generates an overhead image that is obtained by converting a photographed image of surroundings of the vehicle 100 photographed by the camera 110 into an image viewed from an upper side of the vehicle 100.

The parking frame detection unit 132 detects a parking frame around the vehicle 100 by using the overhead image of the photographed image obtained by photographing the surroundings of the vehicle 100.

The parking frame detection accuracy determination unit 133 determines accuracy of the parking frame detected by the parking frame detection unit 132. The parking frame detection accuracy determination unit 133 is an example of an accuracy determination unit.

The target position calculation method determination unit 134 determines, based on the accuracy determined by the parking frame detection accuracy determination unit 133, a method of calculating the target parking position using the parking frame detected by the parking frame detection accuracy determination unit 133 and the parking space detected by the parking space detection unit 135. The target position calculation method determination unit 134 is an example of a calculation method determination unit.

The parking space detection unit 135 detects a parking space based on ultrasonic waves as transmitted waves from the sonar 120 and reflected waves of the transmitted waves.

The target position calculation unit 136 calculates the target parking position based on the determination by the target position calculation method determination unit 134.

The route generation unit 137 generates a route based on the target parking position calculated by the target position calculation unit 136.

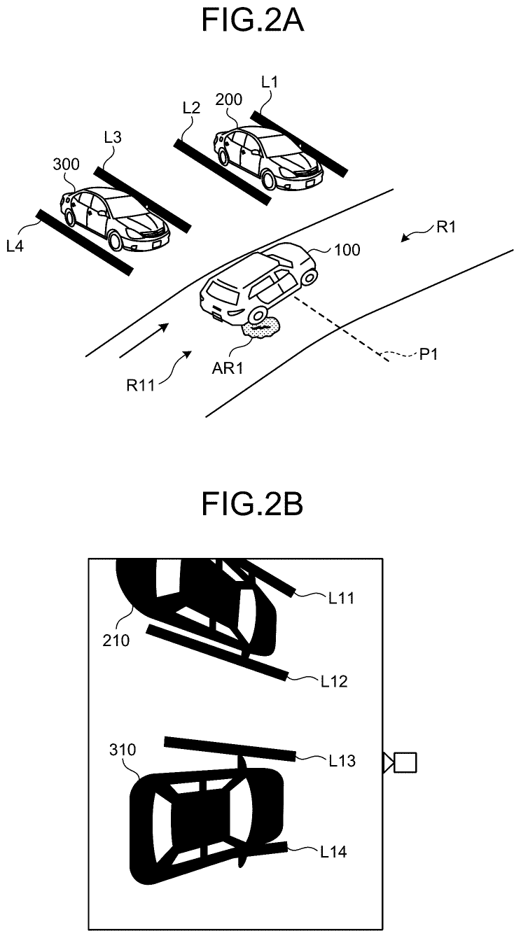

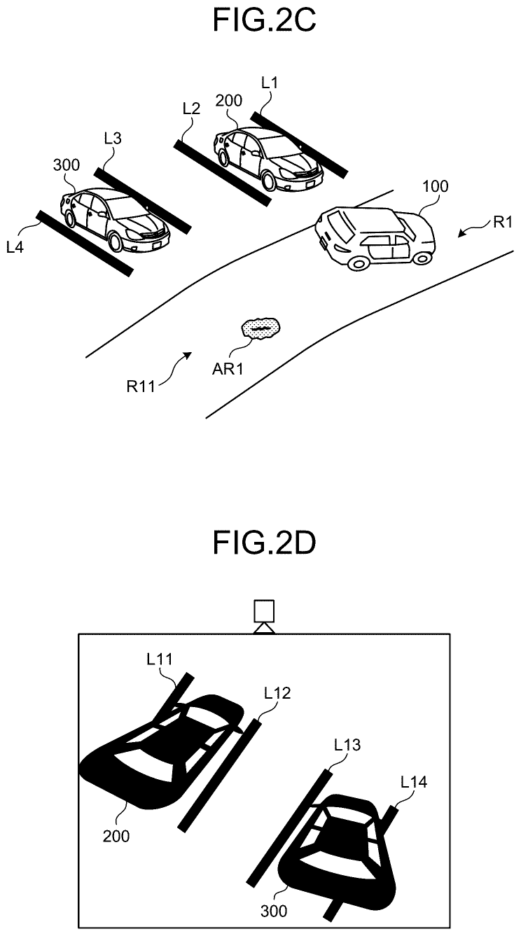

A target position calculation method according to the first embodiment will be described with reference to FIG. 2A to FIG. 2D. FIG. 2A is a diagram illustrating the vehicle 100 driving on a road R1. In a view of the vehicle 100, the road R1 includes an upward slope R11 extending toward a position P1. The road R1 also includes a rough road portion AR1. There are parking frame lines L1 to L4. A vehicle 200 is parked in a parking area partitioned by the parking frame line L1 and the parking frame line L2. Additionally, a vehicle 300 is parked in a parking area partitioned by the parking frame line L3 and the parking frame line L4.

Normally, at the time of performing automatic parking, the vehicle 100 converts an image of the surroundings of the vehicle 100 into an overhead image, and determines the parking frame based on the overhead image. Then, the vehicle 100 calculates the target parking position based on the parking frame, and searches for a route to the target parking position to perform automatic parking based on the route.

FIG. 2B illustrates an example of converting, into the overhead image, the image in which the vehicle 100 is driving on the upward slope R11 as illustrated in FIG. 2A. Normally, the parking frame line L2 and the parking frame line L3 are substantially parallel with each other. However, there are the upward slope R11 and the rough road portion AR1. Thus, the camera 110 is tilted, and the parking frame line L2 and the parking frame line L3 are not parallel with each other. If the vehicle 100 calculates the parking target position by using the image illustrated in FIG. 2B that corresponds to the position of the vehicle 100 in FIG. 2A, the parking target position may be shifted, and the vehicle 100 may be parked at an inappropriate point.

Considering the above issue, the vehicle 100 determines accuracy of the parking frame based on a positional relation between parking frame lines of a parking frame (parking frame partitioned by the parking frame line L2 and the parking frame line L3) at the parking point. Then, the vehicle 100 determines, based on the accuracy, whether to calculate the parking target position only from the overhead image. As illustrated in FIG. 2B, in a case where the parking frame line L2 and the parking frame line L3 are not parallel with each other, the parking frame detection accuracy determination unit 133 of the vehicle 100 determines that parking frame detection accuracy is not high (the parking frame is unavailable). In this case, the target position calculation method determination unit 134 determines to calculate the target position by using a detection result obtained by the parking space detection unit 135.

In the above case, the target position calculation unit 136 calculates the target position by using the detection result obtained by the parking space detection unit 135. Specifically, the target position calculation unit 136 calculates the target position based on information indicating the position of the vehicle 200 detected by the sonar 120 as the detection result obtained by the parking space detection unit 135. The vehicle 100 then performs vehicle control by using the route based on the target position. Due to this, although the vehicle 100 becomes somewhat closer to the vehicle 200, an error can be reduced as compared with a case of calculating the parking target position based on the overhead image.

It is assumed that the vehicle 100 continuously acquires images obtained by the camera 110 and continues to detect parking frames from overhead images of those images. The parking frame detection accuracy determination unit 133 then continues to determine the accuracy of the parking frame detected by the parking frame detection unit 132. In accordance with the determination result of the accuracy of the parking frame, the target position calculation unit 136 recalculates the parking target position. In other words, the parking assist device 130 continuously calculates the parking target position during automatic parking processing. Due to this, the parking assist device 130 can appropriately continue to update the parking target position to an appropriate value.

Subsequently, it is assumed that the vehicle 100 has moved to the position shown in FIG. 2C in accordance with the detection result obtained by the parking space detection unit 135. FIG. 2D illustrates an overhead image at the position of the vehicle 100 shown in FIG. 2C. In this case, a parking frame line portion L12 and a parking frame line portion L13 are parallel with each other. Therefore, the parking frame detection accuracy determination unit 133 determines that the accuracy of the parking frame detected by the parking frame detection unit 132 is high (the parking frame is available). Accordingly, the target position calculation method determination unit 134 determines to calculate the parking target position based on the detection result obtained by the parking frame detection unit 132. The target position calculation unit 136 then calculates the parking target position based on the detection result obtained by the parking frame detection unit 132.

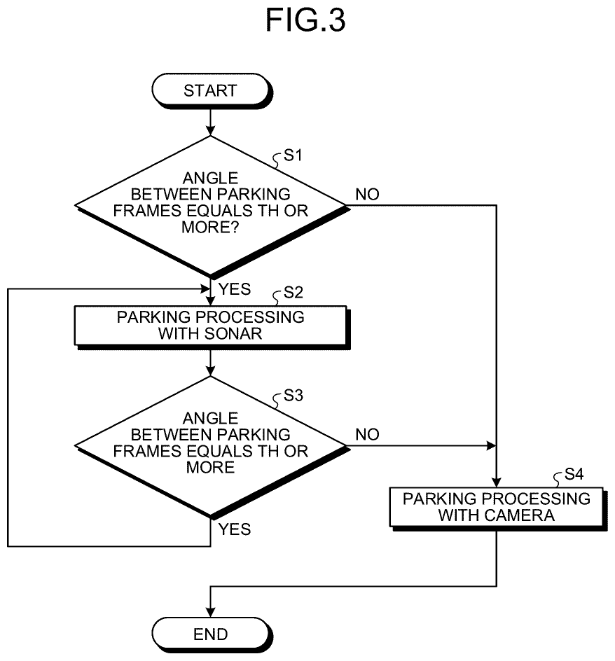

A parking processing procedure performed by the vehicle 100 according to the first embodiment will be described with reference to the flowchart illustrated in FIG. 3.

The parking frame detection accuracy determination unit 133 of the vehicle 100 determines accuracy of a parking frame based on a position and a shape of the parking frame at the parking point. Specifically, the parking frame detection accuracy determination unit 133 determines whether an angle between frame lines of the parking frame is equal to or larger than a threshold (Step S1). If the angle between the frame lines of the parking frame is equal to or larger than a threshold (Yes at Step S1), the parking frame detection accuracy determination unit 133 determines that the parking frame detection accuracy is not high. The vehicle 100 performs parking processing with the sonar (Step S2). As the parking processing with the sonar, the vehicle 100 calculates the target position by using the detection result obtained by the parking space detection unit 135, and performs vehicle control using a route based on the target position.

Subsequently, similarly to the above, the parking frame detection accuracy determination unit 133 of the vehicle 100 determines accuracy of a parking frame based on a position and a shape of the parking frame at the parking point (Step S3). If an angle between the frame lines of the parking frame is equal to or larger than the threshold (Yes at Step S3), the process proceeds to Step S2.

At Step S1 or Step S3, if the angle between the frame lines of the parking frame is smaller than the threshold (No at Step S1, or No at Step S3), the vehicle 100 performs parking processing with the camera (Step S4). As the parking processing with the camera, the vehicle 100 calculates the target position by using the detection result of the parking frame detection unit 132, and performs vehicle control using a route based on the target position.

The parking assist device 130 described above detects a parking frame around the vehicle 100 based on an image obtained by photographing the surroundings of the vehicle 100. The parking assist device 130 also detects a parking space by using the sonar 120. When the accuracy of the parking frame is determined to be high, the parking assist device 130 calculates a parking target position based on the parking frame having high accuracy. When the accuracy of the parking frame is determined to be low, the parking assist device 130 calculates a parking target position based on the parking space. The parking assist device 130 generates a route based on the parking target position.

As described above, the parking assist device 130 determines accuracy of a parking frame. If the accuracy of the parking frame detected from the image is not high, the parking assist device 130 calculates a parking target position by using a parking space obtained by the sonar 120. Therefore, the parking assist device 130 can perform parking assist more appropriately as compared with a case of calculating the parking target position using a parking frame whose accuracy is not high.

### Second Embodiment

The following describes a target position calculation method according to a second embodiment. In the above-described first embodiment, the parking processing is performed with the camera or with the sonar on the basis of accuracy of the parking frame. In the second embodiment, parking processing is performed with the camera and the sonar on the basis of accuracy of the parking frame.

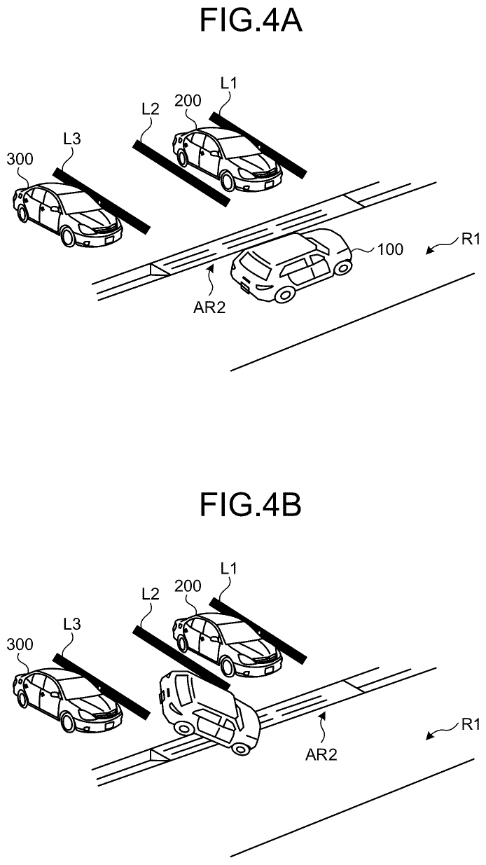

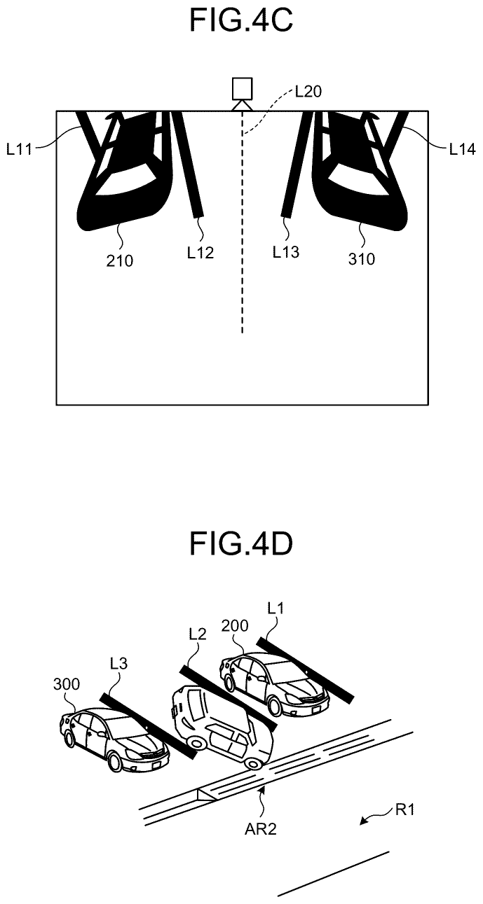

The target position calculation method according to the second embodiment will be described with reference to FIG. 4A to FIG. 4D. FIG. 4A is a diagram illustrating the vehicle 100 driving on the road R1. In a view of the vehicle 100, a stepped portion AR2 is present near the road R1. There are parking frame lines L1 to L3. The vehicle 200 is parked in a parking area partitioned by the parking frame line L1 and the parking frame line L2. Additionally, the vehicle 300 is parked in a parking frame partitioned by the parking frame line L3.

Since there is the stepped portion AR2 as illustrated in FIG. 4A, the parking frame lines L2 and L3 in the overhead image are not parallel with each other. In this case, similarly to the first embodiment, the vehicle 100 performs parking processing with the sonar. Note that the parking frame lines L2 and L3 become parallel with each other after the vehicle 100 climbs over the stepped portion AR2. Therefore, even if the parking target position is corrected at this point in the similar manner to the first embodiment, a remaining drive distance to the parking target position is short, and a route along which the vehicle 100 can move cannot be generated. Additionally, the parking processing with the sonar depends on a nearby vehicle (for example, the vehicle 200) as described above. Therefore, the vehicle 100 is parked at a position deviated from the parking frame.

Considering the above issue, the second embodiment enables the vehicle 100 to park at an appropriate position by performing the parking processing with the camera and the sonar at a position from which a remaining drive distance to the parking target position is sufficiently ensured.

It is assumed herein that the vehicle 100 is climbing the stepped portion AR2 in FIG. 4B. The parking processing with the sonar has been performed up to this time.

FIG. 4C illustrates an overhead image at the position of the vehicle 100 in FIG. 4B. In this case, an angle between the parking frame line portion L12 and the parking frame line portion L13 is equal to or larger than the threshold. However, the parking frame line portion L12 is symmetrical to the parking frame line portion L13, and a center line L20 agrees with a center line of the parking frame including the parking frame line L2 and the parking frame line L3.

This is because, although a true frame line position cannot be estimated from the overhead image because the vehicle 100 is tilted when the vehicle 100 is climbing the stepped portion AR2, the parking frame line portion L12 and the parking frame line portion L13 on the overhead image are bilaterally symmetrical to each other because the camera 110 captures the parking frame on a substantially rear side. In this way, as determination based on the position or the shape of the parking frame, the parking frame detection accuracy determination unit 133 may perform determination based on symmetry of the parking frame in place of based on an angle between the parking frame lines and a threshold determined according to the position.

In this way, when the center line L20 agrees with the center line of the parking frame including the parking frame line L2 and the parking frame line L3, the vehicle 100 performs parking processing with the camera 110 and the sonar 120.

The parking frame detection accuracy determination unit 133 determines that the parking frame detection accuracy is not available but higher than an unavailable state (the parking frame is partially available). Accordingly, the target position calculation method determination unit 134 determines to calculate the target position by using the parking frame detected by the parking frame detection unit 132 for a lateral (right-and-left) direction of the vehicle 100, and using the detection result obtained by the parking space detection unit 135 for a longitudinal (backward-and-forward) direction of the vehicle 100. The target position calculation unit 136 then calculates the target position by using the parking frame detected by the parking frame detection unit 132 and using the detection result obtained by the parking space detection unit 135 for the longitudinal direction of the vehicle 100. The route generation unit 137 generates the route by using the target position.

Subsequently, FIG. 4D illustrates an example in which the vehicle 100 has climbed over the stepped portion AR2. The vehicle 100 performs the parking processing with the camera at this timing.

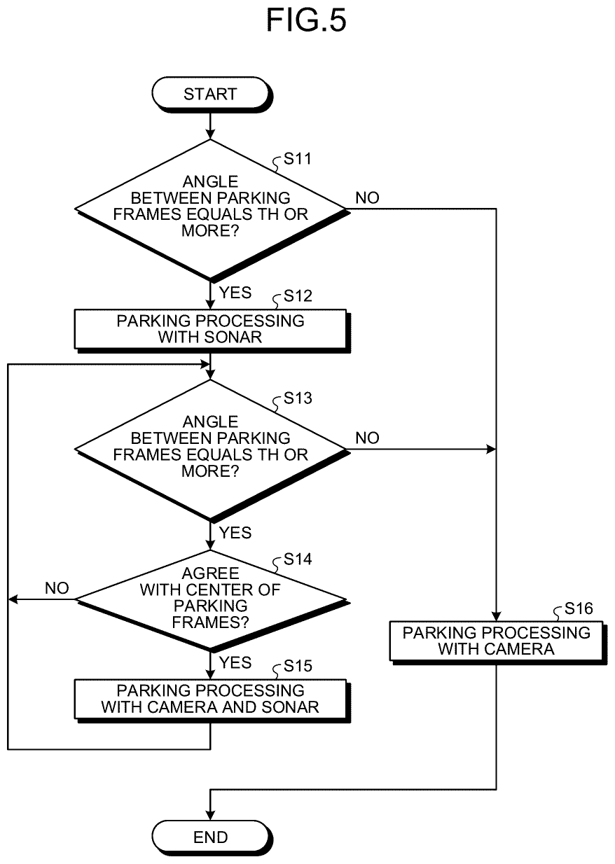

A parking processing procedure performed by the vehicle 100 according to the second embodiment will be described with reference to the flowchart illustrated in FIG. 5.

The parking frame detection accuracy determination unit 133 of the vehicle 100 determines accuracy of the parking frame based on a position and a shape of the parking frame at the parking point. Specifically, the parking frame detection accuracy determination unit 133 determines whether an angle between frame lines of the parking frame is equal to or larger than a threshold (Step S11). If the angle between frame lines of the parking frame is equal to or larger than the threshold (Yes at Step S11), the parking frame detection accuracy determination unit 133 determines that the parking frame detection accuracy is not high. Accordingly, the vehicle 100 performs parking processing with the sonar (Step S12). As the parking processing with the sonar, the vehicle 100 calculates the target position by using the detection result obtained by the parking space detection unit 135, and performs vehicle control using a route based on the target position.

Subsequently, similarly to the above, the parking frame detection accuracy determination unit 133 of the vehicle 100 determines accuracy of the parking frame based on the position and the shape of the parking frame at the parking point (Step S13). If the angle between the frame lines of the parking frame is equal to or larger than the threshold (Yes at Step S13), the process proceeds to Step S14.

At Step S14, the parking frame detection accuracy determination unit 133 determines whether the center between the parking frame line portions L12 and L13 in the overhead image agrees with the center of the parking frame (Step S14). In response to determining that those centers do not agree with each other (No at Step S14), the process proceeds to Step S13. If those centers agree with each other (Yes at Step S14), the vehicle 100 performs the parking processing with the camera 110 and the sonar 120 (Step S15).

At Step S1 or Step S3, if the angle between the frame lines of the parking frame is smaller than the threshold (No at Step S1, or No at Step S3), the vehicle 100 performs parking processing with the camera (Step S16). As the parking processing with the camera, the vehicle 100 calculates the target position by using the detection result obtained by the parking frame detection unit 132, and performs vehicle control using a route based on the target position.

The parking assist device 130 described above performs the parking processing with the camera 110 and the sonar 120 when the accuracy of the parking frame represents that the parking frame is partially available. In this way, the parking assist device 130 performs the parking processing with the camera 110 and the sonar 120 at a timing when the accuracy of the parking frame portion in the overhead image is reliable to some extent. Therefore, the parking assist device 130 can perform the parking processing with higher accuracy than a case of performing the parking processing with the sonar 120 alone.

While the embodiments have been described, these embodiments have been presented by way of example only, and are not intended to limit the scope of the inventions. Indeed, the novel embodiments described herein may be embodied in a variety of other forms; moreover, various omissions, substitutions and changes in the form of the embodiments described herein may be made without departing from the spirit of the inventions. The accompanying claims and their equivalents are intended to cover such forms or modifications as would fall within the scope and spirit of the inventions.

In the embodiment described above, wording of “ . . . unit“may be replaced by other wording such as” . . . circuit (or circuitry)”, “ . . . assembly”, “ . . . device”, “ . . . unit”, or “ . . . module”.

In the embodiments described above, described is the example in which the present disclosure is configured by using hardware, but the present disclosure can also be implemented by software in cooperation with hardware.

Each of the functional blocks used in the explanation of the embodiments described above is typically implemented as an LSI, which is an integrated circuit. The integrated circuit may control the functional blocks used in the explanation of the embodiments described above, and may include an input terminal and an output terminal. The integrated circuit may be individually made into one chip, or the integrated circuit may be made into one chip including part or all of the functional blocks. Herein, the functional block is assumed to be the LSI, but it may be called an IC, a system LSI, a super LSI, or an ultra LSI depending on a difference in integration.

An integrated circuit is not limited to the LSI, but may be implemented by using a dedicated circuit or a general-purpose processor and memories. After manufacturing the LSI, a field programmable gate array (FPGA) that can be programmed, and a reconfigurable processor in which connection or setting of a circuit cell inside the LSI can be reconfigured may be used.

Moreover, if there will be developed a technique of making an integrated circuit replacing the LSI due to advance of a semiconductor technique or another technique derived therefrom, the functional blocks may be integrated using this technique, obviously. Biotechnology may be applied.

The effects of the embodiments described herein are merely examples, and are not limited thereto. Other effects may be exhibited.

What is claimed is:

1. A parking assist system comprising a hardware processor connected to a memory, the hardware processor being configured to:
detect a parking frame around a vehicle based on a photographed image obtained by photographing surroundings of the vehicle;
detect a parking space based on ultrasonic transmitted waves and reflected waves of the ultrasonic transmitted waves;
determine accuracy of the parking frame;
determine, based on the accuracy of the parking frame, a method of calculating a target parking position using the parking frame and the parking space;
calculate the target parking position based on the determination on the method of calculating the target parking position; and
generate a route based on the target parking position.

2. The parking assist system according to claim 1, wherein the hardware processor is configured to
convert the photographed image into an overhead image and detect the parking frame on the overhead image, and
determine the accuracy of the parking frame based on a position or a shape of the parking frame on the overhead image.

3. The parking assist system according to claim 2, wherein the hardware processor is configured to perform the determination based on the position or the shape of the parking frame by using
comparison of an angle between frame lines of the parking frame and a threshold determined according to the position, or
symmetry of the parking frame.

4. The parking assist system according to claim 3, wherein the hardware processor is configured to
determine that the parking frame is unavailable when the angle between the frame lines of the parking frame is equal to or larger than the threshold,
determine that the parking frame is available when the angle between the frame lines of the parking frame is smaller than the threshold, and
determine that the parking frame is partially available when the frame lines of the parking frame are bilaterally symmetrical to each other.

5. The parking assist system according to claim 4, wherein the hardware processor is configured to
determine to calculate the target position by using the parking space in response to a determination result representing that the parking frame is unavailable,
determine to calculate the target position by using the parking frame in response to a determination result representing that the parking frame is available, and,
in response to a determination result representing that the parking frame is partially available, determine to calculate the target position by using the parking frame for a lateral direction of the vehicle and calculate the target position by using the parking space for a longitudinal direction of the vehicle.

6. The parking assist system according to claim 1, wherein the hardware processor is configured to continuously execute the calculation of the target parking position during driving for automatic parking.

7. The parking assist system according to claim 5, wherein the hardware processor is configured to execute the calculation of the target parking position when the determination result meets a specific condition.

8. The parking assist system according to claim 7, wherein the specific condition is one of
a condition where the determination result shifts from the determination that the parking frame is unavailable to the determination that the parking frame is available,
a condition where the determination result shifts from the determination that the parking frame is unavailable to the determination that the parking frame is partially available, and
a condition where the determination result shifts from the determination that the parking frame is partially available to the determination that the parking frame is available.

9. A parking assist method implemented by a computer, the parking assist method comprising:
detecting a parking frame around a vehicle based on a photographed image obtained by photographing surroundings of the vehicle;
detecting a parking space based on ultrasonic transmitted waves and reflected waves of the ultrasonic transmitted waves;
determining accuracy of the parking frame;
determining, based on the accuracy of the parking frame, a method of calculating a target parking position using the parking frame and the parking space;
calculating the target parking position based on the determination on the method of calculating the target parking position; and
generating a route based on the target parking position.

10. The parking assist method according to claim 9, further comprising converting the photographed image into an overhead image and detect the parking frame on the overhead image,
wherein the determining accuracy of the parking frame is performed based on a position or a shape of the parking frame on the overhead image.

11. The parking assist method according to claim 10, wherein the determining based on the position or the shape of the parking frame is performed by using
comparison of an angle between frame lines of the parking frame and a threshold determined according to the position, or
symmetry of the parking frame.

12. The parking assist method according to claim 11, wherein the determining accuracy of the parking frame is performed by
determining that the parking frame is unavailable when the angle between the frame lines of the parking frame is equal to or larger than the threshold,
determining that the parking frame is available when the angle between the frame lines of the parking frame is smaller than the threshold, and
determining that the parking frame is partially available when the frame lines of the parking frame are bilaterally symmetrical to each other.

13. The parking assist method according to claim 12, wherein the determining a method of calculating a target parking position is performed by
determining to calculate the target position by using the parking space in response to a determination result representing that the parking frame is unavailable,
determining to calculate the target position by using the parking frame in response to a determination result representing that that the parking frame is available, and,
in response to a determination result representing that the parking frame is partially available, determining to calculate the target position by using the parking frame for a lateral direction of the vehicle and calculate the target position by using the parking space for a longitudinal direction of the vehicle.

14. The parking assist method according to claim 9, wherein the calculating the target parking position is continuously executed during driving for automatic parking.

15. The parking assist method according to claim 13, wherein the calculating the target parking position is performed when the determination result meets a specific condition.

16. The parking assist method according to claim 15, wherein the specific condition is one of
a condition where the determination result shifts from the determination that the parking frame is unavailable to the determination that the parking frame is available,
a condition where the determination result shifts from the determination that the parking frame is unavailable to the determination that the parking frame is partially available, and
a condition where the determination result shifts from the determination that the parking frame is partially available to the determination that the parking frame is available.
